(19) United States
(12) Patent Application Publication
(10) Pub. No.: US 2024/0080225 A1
(43) Pub. Date: Mar. 7, 2024

(54) WIRELESS COMMUNICATION USING COHERENT TRANSMISSION

(71) Applicant: Sony Group Corporation, Tokyo (JP)

(72) Inventors: Erik Lennart BENGTSSON, Eslöv (SE); José FLORDELIS, Lund (SE); Fredrik RUSEK, Eslöv (SE); Olof ZANDER, Södra Sandby (SE); Kun ZHAO, Malmö (SE)

(21) Appl. No.: 18/272,931

(22) PCT Filed: Nov. 25, 2021
(86) PCT No.: PCT/EP2021/083071

§ 371 Date: Jul. 18, 2023

(30) Foreign Application Priority Data
Feb. 2, 2021 (SE) 2150118-4

(51) Int. Cl. H04L 25/02; H04W 72/20

(52) U.S. Cl. CPC H04L 25/0224; H04W 72/20

(57) ABSTRACT

A method carried out in a User Equipment, UE, for facilitating communication with an access node of a wireless network using coherent transmission, CT, the method comprising: transmitting, to the access node, an indication of requirements of the UE for supporting CT associated with switching between Uplink, U L, and Downlink, DL; obtaining, from the access node, radio configuration for transmitting to the access node based on said requirements for supporting CT, wherein said radio configuration is associated with a certain CT time period.

### TECHNICAL FIELD

This disclosure is related to wireless communication between an access node of a wireless network and a wireless device. Specifically, solutions are provided for facilitating communication with coherent transmission, such as for accomplishing coherent transmission in a time period within which the wireless device is supposed to switch between uplink transmission and downlink reception in a TDD network.

### BACKGROUND

Various protocols and technical requirements for wireless communication have been standardized under supervision of inter alia the 3^{rd} Generation Partnership Project (3GPP). Improvement and further development are continuously carried out, and new or amended functions and features are thus implemented in successive releases of the technical specifications providing the framework for wireless communication.

Wireless communication may in various scenarios be carried out between a wireless network and a wireless device. The wireless network typically comprises an access network including a plurality of access nodes, which historically have been referred to as base stations. In a 5G radio access network such a base station may be referred to as a gNB. Each access node may be configured to serve one or more cells of a cellular wireless network. A variety of different types of wireless devices may be configured to communicate with the access network, and such wireless devices are generally referred to as User Equipment (UE). Communication which involves transmission from the UE and reception in the wireless network is generally referred to as Uplink (UL) communication, whereas communication which involves transmission from the wireless network and reception in the UE is generally referred to as Downlink (DL) communication.

One issue that needs to be considered in wireless communication is channel estimation, such as channel estimation for a Physical Uplink Shared Channel (PUSCH) or a Physical Uplink Control Channel (PUCCH). From here we focus on PUSCH but the technique is valid also for PUCCH transmissions. Such channel estimation may be conducted in the access node, based on a reference signal, or pilot signal, received from the UE.

One challenge associated with channel estimation is related to so-called Joint Channel Estimation (JCE) for PUSCH, based on at least one demodulation reference signal (DMRS) transmitted from the UE, to jointly estimate a reference condition such as symbol phase and amplitude. An instance of transmission of a reference signal, such as DMRS, is here referred to as an occasion. A problem related to the object of using JCE, which involves measuring the DMRS transmitted at two or more occasions from the UE, is that to obtain coherent transmission (CT), such as stability of the DMRS over time. Coherent transmissions greatly simplifies JCE it and improves its performance. The main thing reason for this is the computational simplification. An entirely different class of JCE must be used if transmissions are not coherent. Coherent Transmission at least combines amplitude modulation and phase modulation, to increase information transfer. In order for this to be obtained, it is important that a reference phase for all transmission occasions does not drift or change abruptly, i.e., that the phase is continuous within a certain limit. However, preventing the phase from drifting is very hard. In order to enable JCE it is considered critical that certain parameters or settings are kept substantially constant among multiple PUSCH transmissions, such as one or more, but not limited to, of transmission power, frequency domain resource allocation, DMRS antenna ports, codebook, Tx (transmission) spatial parameters, and timing advance (TA). In addition, there can be no time gap between two adjacent PUSCH transmissions, or the gap between multiple transmissions should at least be short enough. No DL portions can be inserted between two consecutive PUSCH transmissions. If for instance TA is shifted a real time clock in the UE is redefined and this may cause a phase step.

Within the 3GPP, it has been discussed whether JCE can be available more often, or be better supported by UEs, e.g., when the access node is able to do wideband estimation of the relative phase between slots (which as such is discussed in 3GPP document R1-2101522). With regard to the various requirements listed above regarding JCE, it may be argued that the benefit of JCE for TDD (Time Division Duplex) is rather limited for commonly used communication which involves heavy UL/DL switching, or DL:UL ratios, if the UE can only maintain phase continuity for so called back-to-back transmissions. Here, back-to-back transmission may refer to successive transmission occasions which are not interrupted by a change of transmission directions. It can further be assumed that transmissions between an access node and a UE in weak coverage areas are UL limited due to the lower transmit power capability and beam forming capability in a UE compared to a gNB, or due to peak Effective Isotropic Radiated Power (EIRP) capability of the UE.

### SUMMARY

In view of the foregoing, solutions are presented herein for facilitating or configuring communication between an access node and a UE using coherent transmission. The invention is defined by the independent claims, whereas various further advantageous features are set out in the dependent claims.

According to one aspect, a method carried out in a UE is provided, for facilitating communication with an access node of a wireless network using CT, wherein the method comprises:
transmitting, to the access node, an indication of requirements of the UE for supporting CT associated with switching between UL and DL;
obtaining, from the access node, radio configuration for transmitting to the access node based on said requirements for supporting CT, wherein said radio configuration is associated with a certain CT time period.

According to another aspect, a UE is provided which is adapted for facilitating communication with an access node of a wireless network using CT, wherein the UE comprises:
a transceiver for communicating with a wireless network; and
logic configured to control the transceiver to:
   transmit, to the access node, an indication of requirements of the UE for supporting CT associated with switching between UL and DL;
   obtain, from the access node, radio configuration for transmitting to the access node based on said requirements for supporting CT, wherein said radio configuration is associated with a certain CT time period.

According to another aspect, a method carried out in an access node of a wireless network is provided, for configuring communication with UE capable of CT, wherein the method comprises:
receiving, from the UE, an indication of requirements for supporting CT with switching between UL and DL;
transmitting, to the UE, radio configuration for communication with CT based on said requirements, wherein said radio configuration has an associated CT time period.

According to another aspect, an access node of a wireless network is provided, arranged for configuring communication with UE capable of CT, wherein the access node comprises:
a transceiver for communicating with the UE; and
logic configured to control the transceiver to
   receive, from the UE, an indication of requirements for supporting CT with switching between UL and DL; and
   transmit, to the UE, radio configuration for communication with CT based on said requirements, wherein said radio configuration has an associated CT time period.

### BRIEF DESCRIPTION OF THE DRAWINGS

FIG. 1 schematically illustrates an implementation of a wireless communication system, in which a UE communicates with a wireless network through an access node of the network.

FIG. 2 schematically illustrates a UE configured to communicate with the wireless network according to various embodiments.

FIG. 3 schematically illustrates an access node of the wireless network according to various embodiments.

FIG. 4 shows a signaling diagram, illustrating various steps associated with an embodiment wherein a transmit chain of the UE is controlled to obtain a steady load impedance between UL transmission and DL reception within a time period.

FIG. 5 shows a signaling diagram, illustrating various steps associated with an embodiment wherein a transmit chain of the UE is controlled to maintain an active antenna configuration during DL reception within a time period, while DL channel estimation is carried out outside the time period.

FIG. 6 shows a signaling diagram, illustrating various steps associated with an embodiment wherein a transmit chain of the UE is controlled to maintain an active antenna configuration during DL reception within a time period, while beam management is carried out outside the time period.

### DETAILED DESCRIPTION

In the following description, for purposes of explanation and not limitation, details are set forth herein related to various embodiments. However, it will be apparent to those skilled in the art that the present invention may be practiced in other embodiments that depart from these specific details. In the further description, joint channel estimation (JCE) is used as an example, the method also applies to the case where a single DMRS is used as a reference for a PUSCH transmission intersected by DL transmissions. The description below further describes the single input single output (SISO) or single input multiple output (SIMO) scenario with a single transmission layer. It shall, however, be obvious to a person skilled in the art that similar approach can be applied vis-à-vis to the multiple input multiple output (MIMO) scenario, where the UE is configured with multiple simultaneous transmission layers, associated with multiple antenna configurations. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof. The terms “receive” or “receiving” data or information shall be understood as “detecting, from a received signal”.

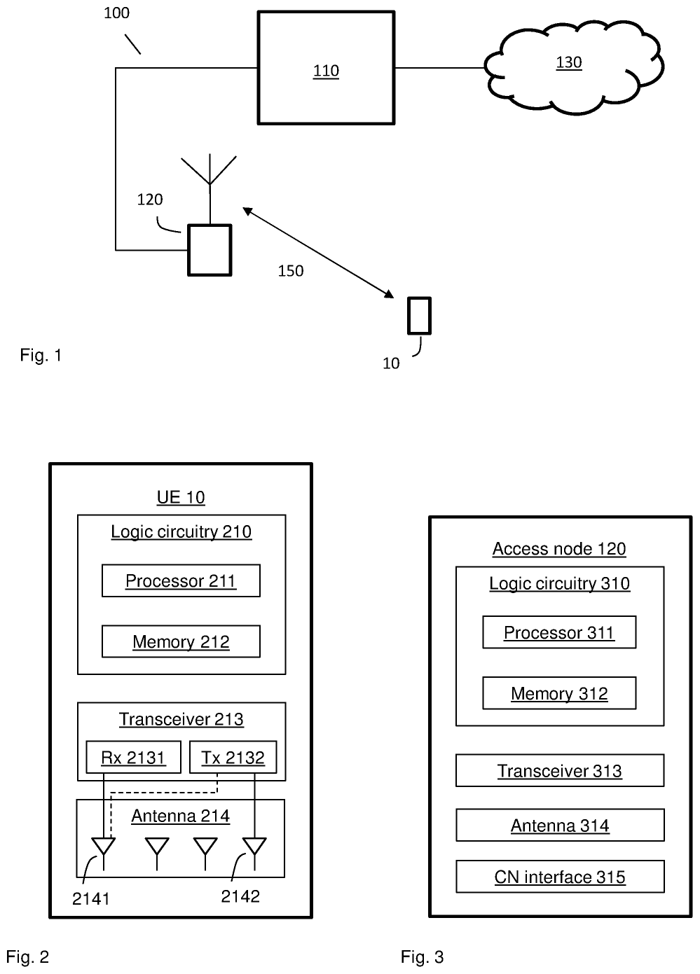

FIG. 1 illustrates a high-level perspective of operation of a UE 10 in a wireless network 100. The wireless network 100 may be a radio communication network 100, configured to operate under the provisions of 5G NR as specified by 3GPP, according to various embodiments outlined herein. The wireless network 100 may comprise a core network 110, which in turn may comprise a plurality of core network nodes. The core network is connected to at least one access network comprising one or more base stations or access nodes, of which one access node 120 is illustrated. The access node 120 is configured for wireless communication 150 with various UEs, of which only the UE 10 is shown. The core network 110 may in turn be connected to other networks 130.

Before discussing further details and aspects of the proposed method, functional elements for the UE 10, configured to carry out the proposed solution, will be briefly discussed.

FIG. 2 schematically illustrates an example of the UE 10 for use in a wireless network 100 as presented herein, and for carrying out various method steps as outlined.

The UE 10 comprises a radio transceiver 213 for communicating with other entities of the radio communication network 100, such as the access node 120, in different frequency bands. The transceiver 213 may thus include a receiver chain (Rx) 2131 and a transmitter chain (Tx) 2132, for communicating through at least an air interface.

The UE 10 may further comprise an antenna system 214, which may include one or more antennas, antenna ports or antenna arrays. In various examples the UE 10 is configured to operate with a single beam, wherein the antenna system 214 is configured to provide an isotropic sensitivity to transmit radio signals. In other examples, the antenna system 214 may comprise a plurality of antennas for operation of different beams in transmission and/or reception. The antenna system 214 may comprise different antenna ports, to which the Rx 2131 and the Tx 2132, respectively, may selectively be connected. For this purpose, the antenna system 214 may comprise an antenna switch. For the sake of illustrating an example, the antenna system 214 is shown to comprise a plurality of individual antennas, including antennas 2141 and 2142, which may be connected by separate antenna ports.

The UE 10 further comprises logic circuitry 210 configured to communicate data, via the radio transceiver, on a radio channel 150, to the wireless communication network 100.

The logic circuitry 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic circuitry 210 may further include memory storage 212, which may include one or multiple memories and/or one or multiple other types of storage mediums. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic circuitry 210 is configured to control the UE to carry out any of the method steps as provided herein. Software defined by said computer program code may include an application or a program that provides a function and/or a process. The software may include device firmware, an operating system (OS), or a variety of applications that may execute in the logic circuitry 210. Obviously, the UE 10 may include other features and elements than those shown in the drawing or described herein, such as a power supply, a casing, a user interface, sensors, etc., but are left out for the sake of simplicity.

FIG. 3 schematically illustrates an access node 120 of the wireless network 100 as presented herein, and for carrying out the method steps as outlined. In various embodiments, the access node 120 is a radio base station for operation in the radio communication network 100, to serve one or more radio UEs, such as the UE 10.

The access node 120 may comprise a wireless transceiver 313, such as a radio transceiver for communicating with other entities of the radio communication network 100, such as the terminal 10. The transceiver 313 may thus include a radio receiver and transmitter for communicating through at least an air interface.

The access node 120 further comprises logic circuitry 310 configured to control the access node 120 to communicate with the UE 10 via the radio transceiver 313 on a radio channel 150.

The logic circuitry 310 may include a processing device 311, including one or multiple processors, microprocessors, data processors, co-processors, and/or some other type of component that interprets and/or executes instructions and/or data. Processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic circuitry 310 may further include memory storage 312, which may include one or multiple memories and/or one or multiple other types of storage mediums. For example, memory storage 312 may include a random access memory (RAM), a dynamic random access memory (DRAM), a cache, a read only memory (ROM), a programmable read only memory (PROM), flash memory, and/or some other type of memory. Memory storage 312 may include a hard disk (e.g., a magnetic disk, an optical disk, a magneto-optic disk, a solid state disk, etc.).

The memory storage 312 is configured for holding computer program code, which may be executed by the processing device 311, wherein the logic 310 is configured to control the access node 120 to carry out any of the method steps as provided herein. Software defined by said computer program code may include an application or a program that provides a function and/or a process. The software may include device firmware, an operating system (OS), or a variety of applications that may execute in the logic 310.

The access node 120 may further comprise, or be connected to, an antenna 314, which may include an antenna array. The logic 310 may further be configured to control the radio transceiver to employ an anisotropic sensitivity profile of the antenna array to transmit radio signals in a particular transmit direction. The access node 120 may further comprise an interface 315, configured for communication with the core network 110. Obviously, the access node 120 may include other features and elements than those shown in the drawing or described herein, such as a power supply and a casing etc.

The proposed solution for obtaining communication between the UE 10 and the access node 120 of the wireless network 100 using coherent transmission, e.g. self-coherent transmission, is in various embodiments based on the notion of enabling the UE to use the separate Rx 2131 and Tx 2132 in the transceiver 213 with individual antenna configurations of the antenna system 214. In this context, individual antenna configuration may in various embodiments imply that the Rx 2131 and the Tx 2132 are connected to individual antennas or antenna ports of the antenna system 214, such as separate antennas or antenna ports 2141, 2142, and which may be different from each other. As a result of using individual antenna configuration for the Rx 2131 and the Tx 2132, respectively, each of those chains work separately and it is thus possible to maintain settings/conditions for the Tx 2132 even during an intermediate DL transmission. For a 5G implementation, this may be the case for lower frequencies, such as the Frequency Range FR1 (such as sub 7 GHz). For a mm wave frequency range, such as FR2, different antenna configuration may involve connection of the Rx 2131 and the Tx 2132, respectively, to different antenna panels, antenna elements, or antenna ports, to configure different beams. In general, the method can be used in any frequency band for a TDD network, also beyond the frequency ranges defined above.

According to one aspect, the proposed solution provides that a signal path for the Tx is subjected to a constant load impedance, within a certain predetermined limit or with a certain level of accuracy for the duration of certain time period during which coherent transmission is to be employed, herein referred to as a CT time period. This CT time period may be defined as, or dependent on, a window for joint channel estimation, JCE. This time period may in various embodiments be set by specification, or may be communicated by the access network, such as in system information, or may be determined by the UE based on information received from the access node 120 using a predetermined rule, such as by calculation or using a look-up table. As a result, transmission by the TX 2132, such as DMRS transmission, may be carried out throughout the CT time period reference signals without instantaneous amplitude or phase drift caused by UL/DL switching.

According to some embodiments, the Tx 2132 is continuously biased and connected all the way to the antenna 214 during reception, i.e., during slots which are allocated for DL reception using the Rx 2131. In various embodiments, the Tx 2132 is thus connected with a first antenna, antenna port, or antenna panel 2142, of the antenna system 214, and kept active without transmitting anything during the DL slots. Concurrently, the Rx 2131 is connected to another antenna, antenna port, or antenna panel 2141 of the antenna system 214 and for receiving DL signals from the access node 120.

In various embodiments, in which subjecting the Tx 2132 to a constant load impedance in allocated DL slots is an optional arrangement for the UE 10, the proposed solution may involve signaling between the UE 10 and the access node 120. This may be accomplished by the UE 10 being configured to transmit an indication of requirements of the UE 10 for supporting CT, associated with UL/DL switching.

In some embodiments, the indication of requirements indicates whether or not CT transmission is supported.

In some embodiments, the indication of requirements indicates circumstances in which CT transmission is supported, such as indicating a certain maximum CT time period and/or a frequency range or bandwidth parts (BWP). A circumstance may be that the UE is not capable of entering receive mode at all during the CT period. Therefore, DL transmissions for the UE 10 shall not be scheduled by the access node 120 in DL resources within the CT time period (DL resources, i.e., OFDM symbols and slots are configured for all UEs in a cell as part of the frame structure). Alternatively, or in effect, the UE 10 is allowed to disregard all DL transmissions within the CT time period. A further embodiment could be that the UE 10 indicates a circumstance that it shall be allowed by the access node 120 to transmit during the DL slot within the CT time period. Another circumstance may be that beam management is not allowed within the CT period. Yet another circumstance may be that SRS transmission for the purpose of sounding the DL channel cannot be scheduled within the CT period. Further circumstances may be that CT transmissions are only supported at some power levels, e.g. associated with weak signal conditions or modulation schemes (e.g. 1024 QAM may not be supported). If communication is configured by the access node 120 such that the circumstances violate the requirements, CT cannot be assumed by the access node 120. In various scenarios, the proposed solution is more likely to be used for UEs 10 at an edge of a cell, i.e. far from the access node 120 serving the cell. In some embodiments, a threshold is defined to activate communication in accordance with any of the embodiments outlined herein of the proposed solution, for UL and DL communication within a CT time period. A threshold criteria may thus control the access node to provide configuration in accordance with any of the embodiments outlined herein, including UL reference signals or beam management configured outside the CT time period of communication. The threshold criteria may be triggered when a power level of a received signal or a transmitted signal at the UE or the access node meets a threshold level, such as when transmit power exceeds a power level. In some embodiments, the threshold criteria is triggered by a predetermined modulation order. This way, the proposed solution may be activated only for lower modulation orders, such as below a certain modulation order threshold.

In some embodiments, the indication of requirements conveys to the access node 120 that the UE 10 is capable of radio configuration of at least two occasions of UL transmission with an intermediate DL reception within said CT time period.

In some embodiments, the indication of requirements conveys that any uplink signaling, e.g. SRS, for obtaining channel state information, e.g. for estimation of the channel used in the DL, must be scheduled outside the CT time period, such as prior, as will be described further below.

In some embodiments, the indication of requirements conveys that any beam management/configuration for UL/DL beam identification must be scheduled outside the CT time period, e.g. that the beam management/configuration must be completed prior to the CT time period.

The indication of requirements may in various embodiments thus provide to the access node 120 that the UE 10 supports JCE although there is DL/UL switching within a time period that JCE is applied over, and potentially further restrictions that may be fulfilled, such as one of those exemplified.

In some embodiments, the indication of requirements conveys to the access node 120 that the UE 10 is capable of managing an amplitude and/or phase shift in the Tx 2132 between UL transmission occasions separated by DL reception during the CT time period, so as to maintain a substantially constant amplitude and/or phase. In some embodiments, managing the amplitude and/or phase shift involves not exceeding a certain predetermined amplitude and/or phase shift level between two UL transmission occasions separated by DL reception during the CT time period.

In various embodiments, the indication of requirements is conveyed as capability information for the UE 10. Such capability information may be conveyed by the UE 10 responsive to a UE capability enquiry from the wireless network 100. It should be understood that the capability information may be conveyed at any point in time, and to any access node of the network 100, for storing in the wireless network 100, such as in the core network 110. The access node 120 may subsequently obtain the indication of requirements, e.g. capability information, from a node of the wireless network 100 in which the capability information is stored.

When CT is facilitated by using separate UL and DL antenna configurations, one consequence is that UL and DL reciprocity and/or beam correspondence (BC) does not apply. For FR2, this has the implication that dedicated UL beam management may be needed. The reason why reciprocity is not present follows from the fact that different UL and DL antenna configurations are used in the UE 10. This is schematically illustrated in FIG. 2, wherein the Rx 2131 is connected with a first antenna configuration, and the Tx 2132 is individually connected with another antenna configuration, wherein the separate and different antenna configurations are exemplified in the drawing by different antenna elements. This may have consequences on the scheduling of resources, as carried out by the access node 120 for the UE 10. For this purpose, the Rx 2131 including its connected antenna is in some embodiments configured by the access node 120 for transmission of UL reference signals, or pilots, of a second type, such as Sounding Reference Signals (SRS), outside the CT time period where JCE may apply. The purpose of the second type of UL reference signal, e.g. SRS, is to obtain a channel estimate of the DL channel. However, since this reference signal are for Rx channel estimate it has to be transmitted from the Rx antenna, i.e. with the antenna configuration used for the Rx 2131 during DL reception. Hence, this requires coupling the Tx 2132 to the Rx antenna 2141, as illustrated by the dashed connection in FIG. 2, which may cause above-mentioned phase and/or amplitude shift problems. Reciprocity-based communication is otherwise an operational mode which is suitable for TDD where UL and DL use the same frequency band, but also for FDD (Frequency Division Duplex), where e.g. delay and angular reciprocity may be used. Based on channel estimation in one direction, e.g. UL SRS, the access node 120 can use the same precoder for both UL and DL traffic (which is not the case when the UE use different antenna configurations for UL/DL traffic). This is particularly advantageous when the access node is equipped with or connected to an antenna system 314 comprising a large number of antennas, such as in a deployment of massive MIMO (Multiple-Input and Multiple-Output).

In various scenarios, most channels can be assumed to be UL limited. For this reason, the antenna configuration, i.e. the antenna, antenna port or antenna panel, which detects the strongest channel in the UE 10 shall be associated with the UL, i.e. the Tx 2132.

In various embodiments, the logic circuitry 210 of the UE 10 is configured to control the Tx 2132 to counteract a phase drift at the Tx 2132, while slots are allocated for DL reception using the Rx 2131 in the CT time period. In accordance with what has been outlined above, controlling of the Tx 2132 may in some embodiments comprise maintaining an active connection of the Tx 2132 associated with a first antenna configuration during time slots allocated for DL reception in the CT time period using the Rx 2131 associated with a second antenna configuration, in order to counteract a phase and/or amplitude shift of UL reference signals. While this may entail a negative impact on power consumption, it may nevertheless be sufficiently small compared to the benefit obtained by enabling channel estimation in in the CT time period, such as joint channel estimation. When JCE applies, the access node 120 can use “averaging” over multiple DMRS at both side of the DL slots. A benefit of JCE is that UL reference signals can be combined coherently at the access node 120, thereby increasing the quality of the channel estimates (i.e., by pushing further down receiver noise). Better channel estimates may translate into reduced bit error rates during UL payload detection/decoding and further less re-transmissions. This way, the UE 10 may further benefit from a resulting extended UL coverage. In particular, the cost of power consumption may be small depending on the transmission scheme, i.e. UL/DL ratio.

In an alternative embodiment, the logic circuitry 210 may rather be configured to control the Tx 2132 to obtain a steady load impedance upon switching between UL transmission and DL reception in the CT time period. This way, even though the antenna configuration for the Tx 2132 is disconnected during DL reception, it will maintain connected to a corresponding impedance. Once the Tx 2132 is again connected with the same antenna configuration as for the UL period prior to the DL reception, the same phase will be maintained, i.e. without causing a phase shift which exceeds a certain threshold. By this arrangement, no special attention needs to be paid to radio/channel configuration of the UL signaling of SRS. The indication of requirements may thus simply state that the UE 10 is capable of supporting whether or not CT transmission is supported, and potentially specifically that the UE 10 is capable of radio configuration of at least two occasions of UL transmission with an intermediate DL reception within said CT time period. In some embodiments, obtaining a steady load impedance may involve terminating the Tx 2132 with a predetermined load impedance during DL reception in the CT time period. This may include switching from a connection of the Tx 2132 in accordance with a first antenna configuration, such as to a certain antenna port, during UL transmission, to the predetermined impedance member during DL transmission. The load impedance member may be configured to emulate or be similar to the impedance provided by said first antenna configuration.

Various embodiments including functions outlined above will now be described using signaling diagrams. As seen from the UE 10, the signaling diagrams relate to facilitating communication with the access node 120 of the wireless network 100, using coherent transmission, CT. As seen from the access node 120, the signaling diagrams relate to configuring communication with the UE 10, which is capable of CT. The method involves transmitting a first type reference signal, such as a DMRS, at one or more occasions from the UE 10 to the access node 120, which may be used in the access node for channel estimation for one or both antenna configurations associated with UL and DL transmissions. It may be noted that for any of these embodiments, UL/DL switching in the CT window may comprise different radio configuration and more switching than the shown UL-DL-UL allocation, such as e.g. UL-DL-UL-DL-UL, but will nevertheless comprise at least two UL occasions with a DL occasion in between.

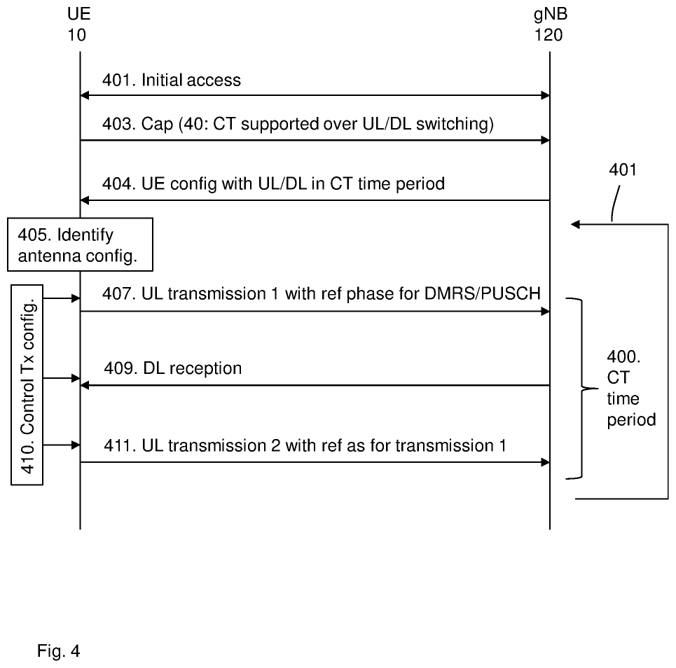

FIG. 4 schematically illustrates a signaling diagram for an embodiment in which the UE 10 is configured to control a transmit chain, i.e. the Tx 2132, used for UL transmission to counteract its phase drift during DL reception using the receive chain, i.e. Rx 2131 in the CT time period 400.

The method may be preceded by initial access 401, which may comprise interaction of messages Msg 1 to Msg 4 in a four-step RACH scenario, or messages A and B in a two-step RACH scenario.

In a step 403, an indication 40 of requirements is transmitted to the access node 120, which indication conveys that the UE 10 supports CT associated with UL/DL switching. Specifically, the indication 40 of support may be based on the UE 10 not requiring handling of individual antenna configuration for the Rx 2131 and the Tx 2132, respectively.

In step 404, the UE 10 obtains radio configuration, such as channel configuration, from the access node 120, for transmitting to the access node 120 based on said requirements, wherein said radio configuration is associated with a certain CT time period 400. As noted, the CT time period may be predetermined, or may be signaled by the access node 120, or may be concluded by the UE 10 based on obtained information such as the size of a transport block (TB).

In some embodiments, the radio configuration indicates to the UE 10 that communication shall be made using coherent transmission. This may be indicated specifically by information bits, or implicitly based on a certain scheduling of e.g. UL reference signals. In an alternative embodiment, separate signaling (not shown) may be provided from the access node 120 to the UE 10, may comprise information from the access node, indicating that communication shall be made using coherent transmission.

The radio configuration may comprise allocation of resources for both data communication in UL and DL, as well as resource allocation for the first type of reference signal, e.g. DMRS, to be carried out in the CT time period 400. This type of resource allocation may be determined based on the indication 40 of requirements.

In step 405, the logic circuitry 210 may be configured to identify separate antenna configuration for DL and UL communication, prior to said CT time period 400.

Subsequently, the method may comprise communicating between the UE 10 and the access node 120 in accordance with the radio configuration, comprising at least two occasions 407, 411 of UL transmission with an intermediate DL reception 409 within said CT time period 400, wherein each transmission occasion comprises slots allocated for UL transmission. The UL transmission 407 and/or 411 may comprise transmitting a first type UL reference signal, such as DMRS, to be measured in the access node 120 to obtain a reference for the CT time period 400. In some embodiments, the first type UL reference signal is transmitted at least twice within the CT time period 400 to obtain at least two references for joint channel estimation.

The signaling may loop 401 to be repeated, where the reference phase may be redefined each iteration. Each iteration may optionally also include the step of identifying 405 antenna configuration for UL and DL. Within the UL transmission periods 407, 411 and the DL reception period of one iteration, the same antenna configuration may be employed for UL and DL.

In accordance with the embodiment of FIG. 4, the Tx 2132 of the transceiver 213 in the UE 10 is controlled 410 to be reconfigured between transmission 407, 411, and DL reception 409, so as to counteract its phase drift during DL reception. This way, the second UL transmission 411 is carried out with the same reference phase as for the first transmission 407, such as for DMRS and PUSCH. Specifically, the logic 210 may be configured to apply an impedance load to the Tx 232 during DL reception, so as to maintain a steady load on the Tx 2132.

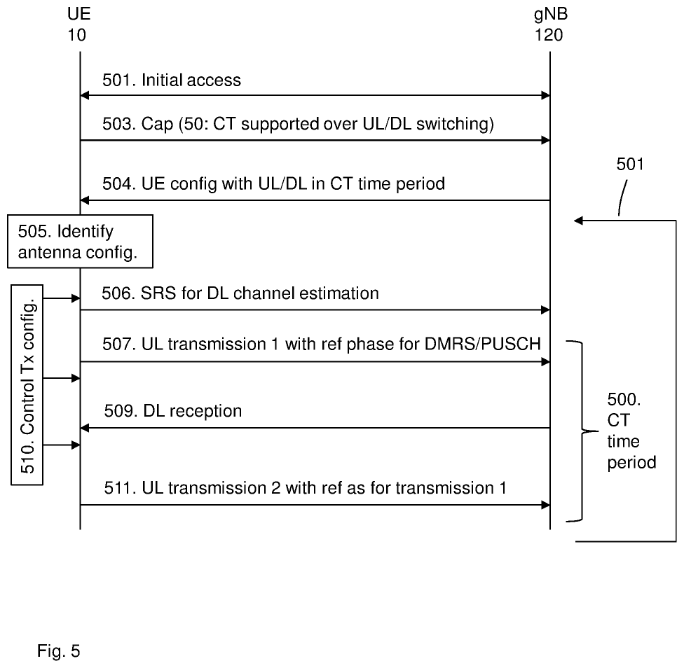

FIG. 5 schematically illustrates a signaling diagram for an embodiment in which reciprocity-based SRS channel estimation is carried out, for obtaining channel state information, e.g. for channel estimation of the DL channel. In this embodiment, the UE requires individual antenna configuration for the Rx 2131 and the Tx 2132, such as antenna 2141 and antenna 2142, respectively, to provide coherent transmission within a CT time period 500.

The method may be preceded by initial access 501, which may comprise interaction of messages Msg 1 to Msg 4 in a four-step RACH scenario, or messages A and B in a two-step RACH scenario.

In a step 503, an indication 50 of requirements is transmitted to the access node 120, which indication conveys that the UE 10 supports CT associated with UL/DL switching. The indication 50 may thus provide requirements indicating that the UE 10 supports CT under certain circumstances. In some embodiments, the requirements are related to UL/DL switching. In some embodiments, the indicated requirements enables use of individual antenna configuration for Rx 2131 and Tx 2132 DL/UL, respectively, in the UE 10, as exemplified herein. In some embodiments, the requirements prescribe a need for a specific configuration of UL reference signals, such as SRS, for channel estimation of a DL channel. In some embodiments, the requirements prescribe configuration of an UL reference signal, such as SRS, at a certain relative point in time, such as outside the CT window, or at least a certain time gap prior to the CT time period or prior to a first UL period or DL period within a CT time period. The signaling 503 provides inter alia the indication 50 that uplink signaling of a second type, e.g. SRS, for estimation of the channel used in the DL, must be scheduled outside the CT time period.

In step 504, the UE 10 obtains radio configuration, such as channel configuration, from the access node 120, for transmitting to the access node 120 based on said requirements, wherein said radio configuration is associated with a certain CT time period 500. As noted, the CT time period may be predetermined, or may be signaled by the access node 120, or may be concluded by the UE 10 based on obtained information, e.g., TB size.

In some embodiments, the radio configuration indicates to the UE 10 that communication shall be made using coherent transmission. This may be indicated specifically by information bits, or implicitly based on a certain scheduling of e.g. UL reference signals. In an alternative embodiment, separate signaling (not shown) may be provided from the access node 120 to the UE 10, which may comprise information from the access node, indicating that communication shall be made using coherent transmission.

The radio configuration may comprise allocation of resources for both data communication in UL and DL, as well as resource allocation for the first type of reference signal, e.g. DMRS, to be carried out in the CT time period 400. Moreover, the radio configuration may comprise allocation of resources for other UL reference signals, such as SRS, outside the CT time period. This type of resource allocation may be determined based on the indication 50 of requirements.

In step 505, the logic circuitry 210 may be configured to identify separate antenna configuration for DL and UL communication.

In step 506, the UE 10 transmits an UL reference signal of the second type, e.g. SRS, according to said radio configuration. This may be accomplished by the Tx 2132, using an antenna configuration 2141 used for DL reception in the CT time period. This step is carried out prior to the CT time period 500. Based on the second type reference signal, the access node 120 performs channel estimation which is applicable for the present antenna configuration of UE 10, which antenna configuration may be maintained during subsequent DL reception 509.

Subsequently, the method may comprise communicating between the UE 10 and the access node 120 in accordance with the radio configuration, comprising at least two occasions 507, 511 of UL transmission with an intermediate DL reception within said CT time period 500. The UL transmission 507 and/or 511 may comprise transmitting a first type UL reference signal, such as DMRS, to be measured in the access node 120 to obtain a reference for the CT time period 500. In some embodiments, the first type UL reference signal is transmitted at least twice within the CT time period 500 to obtain at least two references for joint channel estimation.

The UL transmission 507, 511 is carried out using a first antenna configuration 2142 in association with the Tx 2132, whereas reception 509 is carried out using a second antenna configuration 2141 in association with the Rx 2131. In various embodiments, this entails controlling 510 the Tx 2132 to maintaining an active connection associated with the first antenna configuration during time slots allocated for DL reception 509 between occasions of UL transmission 507, 511 in the CT time period 500. The logic circuitry 210 of the UE 10 may further be configured to control 510 the transceiver 213 such that the second antenna configuration, used also for DL reception 509, is that which was used for SRS transmission 506.

The signaling may loop 501 to be repeated, where the reference phase may be redefined each iteration. Each iteration may optionally also include the step of identifying 505 antenna configuration for UL and DL.

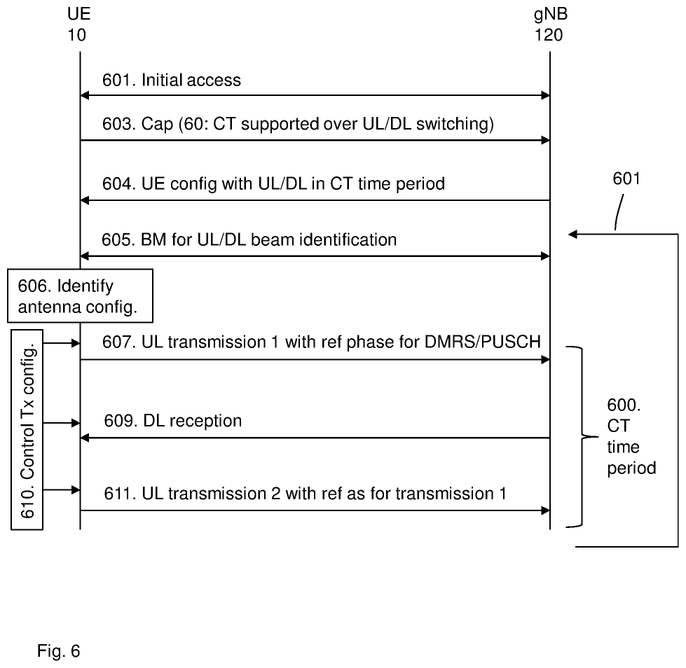

FIG. 6 schematically illustrates a signaling diagram for an embodiment in which beam management is carried out, for determining different UL and DL beams or beam pairs to be used for communication in a CT time period 600. In this embodiment, the UE 10 requires individual beam identification and configuration for the Rx 2131 and the Tx 2132 to provide coherent transmission within a CT time period 500.

The method may be preceded by initial access 601, which may comprise interaction of messages Msg 1 to Msg 4 in a four-step RACH scenario, or messages A and B in a two-step RACH scenario.

In a step 603, an indication 60 of requirements is transmitted to the access node 120, which indication conveys that the UE 10 supports CT associated with UL/DL switching. The signaling 60 may provide inter alia the indication beam correspondence (BC) is not supported for UL/DL switching during the CT time period 600. In some embodiments, the indication thus provides that switching between UL transmission using the Tx 2132 and DL reception using the Rx 2131 requires different beam configuration for UL and DL. For, at least, application in the mm wave spectrum, such as FR2, this has the implication that dedicated UL beam management is needed, prior to the CT time period 600. As noted, the CT time period may be predetermined, or may be signaled by the access node 120, or may be concluded by the UE 10 based on obtained information. The indication 60 may thus provide requirements indicating that the UE 10 supports CT under certain circumstances. In some embodiments, the requirements are related to UL/DL switching. In some embodiments, the indicated requirements enables use of individual antenna configuration for Rx 2131 and Tx 2132 DL/UL, respectively, in the UE 10, as exemplified herein. In some embodiments, the requirements prescribe a need for a beam configuration or management, to obtain individual configuration for the Rx 2131 and the Tx 2132. In some embodiments, the requirements prescribe beam identification at a certain relative point in time, such as outside the CT window, or at least a certain time gap prior to the CT time period or prior to a first UL period or DL period within a CT time period. The beam management may relate to measuring SSB and/or CSI-RS, reporting such measurement, for each of the UL and DL antenna configurations.

In step 604, the UE 10 obtains radio configuration from the access node 120, for transmitting to the access node 120 based on said requirements, wherein said radio configuration is associated with a certain CT time period 600. As noted, the CT time period may be predetermined, or may be signaled by the access node 120, or may be concluded by the UE 10 based on obtained information.

In some embodiments, the radio configuration indicates to the UE 10 that communication shall be made using coherent transmission. This may be indicated specifically by information bits, or implicitly based on a certain scheduling of e.g. UL reference signals. In an alternative embodiment, separate signaling (not shown) may be provided from the access node 120 to the UE 10, may comprise information from the access node, indicating that communication shall be made using coherent transmission.

The radio configuration may comprise allocation of resources for both data communication in UL and DL, as well as resource allocation for the first type of reference signal, e.g. DMRS, to be carried out in the CT time period 600. Moreover, the radio configuration may comprise allocation for beam management outside the CT time period 600. This type of resource allocation may be determined based on the indication 60 of requirements.

In step 605, the UE 10 and the access node 120 carries out beam management, which may include the UE 10 reporting measurements obtained based on a beam sweep of the access node 120 and/or the UE 10. In various embodiments, the beam management 605 may comprise dedicated UL transmit beam scanning (SRS) by the UE for FR2, or UL beam management (i.e. Rx beam scanning at the UE) based on CSI-RS/SSB (i.e. DL pilots) outside the CT time period. The beam management may also include that the UE 10, use the transmit antenna configuration to receive CSI-RS outside the CT time period 600.

In step 606, the logic circuitry 210 may be configured to identify separate antenna configuration for DL and UL communication, prior to said CT time period 600, in accordance with the beam management 605.

Subsequently, the method may comprise communicating between the UE 10 and the access node 120 in accordance with the radio configuration, comprising at least two occasions 607, 611 of UL transmission with an intermediate DL reception within said CT time period 600. The UL transmission 607 and/or 611 may comprise transmitting a first type UL reference signal, such as DMRS, to be measured in the access node 120 to obtain a reference for the CT time period 600. In some embodiments, the first type UL reference signal is transmitted at least twice within the CT time period 600 to obtain at least two references for joint channel estimation.

UL transmission 607, 611 is carried out using a UL beam whereas DL reception 609 is carried out using a DL beam, in accordance with the beam management of step 605.

The UL transmission 607, 611 is carried out using a first antenna configuration in association with the Tx 2132, whereas reception 609 is carried out using a second antenna configuration in association with the Rx 2131. In various embodiments, this entails controlling 610 the Tx 2132 to maintain an active connection associated with the first antenna configuration during time slots allocated for DL reception 609 between occasions of UL transmission 607, 611 in the CT time period 600.

The signaling may loop 601 to be repeated, where the reference phase may be redefined each iteration. Each iteration may optionally also include the step of beam management for UL/DL beam identification 605.

Various features and functions of different embodiment are presented herein. Except where clearly contradictory, these features and functions can be combined in any way.

1. A method carried out in a User Equipment (UE) for facilitating communication with an access node of a wireless network using coherent transmission (CT) the method comprising:
transmitting, to the access node, an indication of requirements of the UE for supporting CT associated with switching between Uplink (UL) and Downlink (DL);
obtaining, from the access node, radio configuration for transmitting to the access node based on said requirements for supporting CT, wherein said radio configuration is associated with a certain CT time period.

2. The method of claim 1, comprising:
communicating with the access node in accordance with the radio configuration, comprising at least two occasions of UL transmission with an intermediate DL reception within said CT time period.

3. The method of claim 1, wherein said indication of requirements is identified by UE capability information.

4. The method of claim 1, comprising:
transmitting a first type UL reference signal (DMRS) to be measured in the access node to obtain a reference for the CT time period.

5. The method of claim 4 comprising:
transmitting the first type UL reference signal (DMRS) at least twice within the CT time period to obtain at least two references for joint channel estimation.

6. The method of claim 4, wherein said indication of requirements identifies a need for radio configuration of a second type UL reference signal (SRS) outside of said CT time period, usable for obtaining DL channel state information.

7. The method of claim 6, comprising:
transmitting an UL reference signal (SRS) of the second type according to said radio configuration, prior to said CT time period.

8. The method of claim 7, wherein said radio configuration identifies at least a first resource for the first type UL reference signal (DMRS) during said CT time period and at least a second resource for the second type UL reference signal (SRS) outside of said CT time period.

9. The method of claim 1, wherein said indication of requirements is associated with use of separate antenna configurations for transmitting and receiving at the UE during the CT time period.

10. The method of claim 1, comprising:
identifying separate antenna configuration for DL and UL communication, prior to said CT time period.

11. The method of claim 10, wherein the separate antenna configurations are configured for communication with different beams of the access node.

12. The method of claim 1, comprising:
controlling a transmit chain, used for UL transmission, to counteract a phase drift at the transmit chain, during DL reception using a receive chain in the CT time period.

13. The method of claim 6, comprising:
controlling a transmit chain, used for UL transmission, to counteract a phase drift at the transmit chain, during DL reception using a receive chain in the CT time period, and wherein controlling comprises:
maintaining an active connection of the transmit chain associated with a first antenna configuration during time slots allocated for DL reception in the CT time period using the receive chain associated with a second antenna configuration.

14. The method of claim 12, wherein controlling comprises:
controlling the transmit chain to obtain a steady load impedance between UL transmission and DL reception in the CT time period.

15. The method of claim 14, comprising:
terminating the transmit chain with a predetermined load impedance during DL reception in the CT time period.

16. The method of claim 1, comprising:
receiving information from the access node, indicating communication using coherent transmission.

17. A method carried out in an access node of a wireless network for configuring communication with a User Equipment (UE), capable of coherent transmission (CT), the method comprising:
receiving, from the UE, an indication of requirements for supporting CT with switching between Uplink (UL) and Downlink (DL);
transmitting, to the UE, radio configuration for communication with CT based on said requirements, wherein said radio configuration has an associated CT time period.

18. The method of claim 17, comprising:
communicating with the UE in accordance with the radio configuration, comprising at least two occasions of UL transmission with an intermediate DL reception within said CT time period.

19. The method of claim 17, wherein said indication of requirements is identified by UE capability information.

20. The method of claim 17, wherein said indication of requirements identifies use of a separate antenna configuration for transmitting and receiving signals at the UE during the CT time period.

21-32. (canceled)
